(19) United States
(12) Patent Application Publication
(10) Pub. No.: US 2005/0021842 A1
(43) Pub. Date: Jan. 27, 2005

(54) Real-time packet classification and rate-limiting control packets in a network processor based data-plane

(75) Inventors: Rajesh Narayanan, Santa Clara, CA (US); Aaron Williams, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Network Equipment Technologies, Fremont, CA (US)

(21) Appl. No.: 10/642,042

(22) Filed: Aug. 15, 2003

Related U.S. Application Data
(60) Provisional application No. 60/455,731, filed on Mar. 17, 2003.

(51) Int. Cl. G06F 15/173; G06F 15/16

(52) U.S. Cl. 709/238; 709/207

(57) ABSTRACT

A method for managing packets in a network is presented comprising the steps of receiving a packet, assigning the packet to a selected one of a plurality of classes, checking a counter associated with the selected class, advancing the counter toward the target value and forwarding the packet if the counter is not equal to a target value, dropping the packet if the counter is equal to the target value, and from time to time, resetting the counter to a reset value not equal to the target value to allow more packets from the selected class to be forwarded. In one embodiment, the counter is scheduled to be repeatedly reset according to a period, which may be implemented by use of a timer. The period, the reset value, and/or the target value can be changed to effectuate a different rate of packet forwarding for the selected class.

### CROSS-REFERENCES TO RELATED APPLICATIONS

This application claims priority from U.S. Provisional Application No. 60/455,731, filed Mar. 13, 2003. The 60/455,731 application is incorporated herein by reference.

### BACKGROUND OF THE INVENTION

In traditional networking systems, it is often difficult to protect against high levels of network traffic that can lead to system inefficiencies or even complete system breakdowns. For example, various denial of service (DOS) attacks can lead to such high levels of network traffic. A typical DOS attack operates by inundating a system with unexpectedly large amounts of network control traffic, to the point of tying up or breaking down normal services provided by the system. High levels of network traffic may also be undesirable under more normal operations, outside of any DOS attack. For instance, on occasion large number of users of a connection-oriented service may all attempt to connect to a system at one time. The system may not be able to handle the peak in network control traffic resulting from requests for connection from these users all at once. Again, high levels of network traffic may lead to loading of resources beyond their capabilities, which can cause the tie up or break down of normal services provided by the system. Thus, undesirably high levels of network traffic is a potentially catastrophic problem that can arise in many different situations in a network environment.

Existing designs have not provided a satisfactory solution to this problem. Such designs either discard network traffic indiscriminately or do so according to some sort of rudimentary priority assignment. Also, such designs typically fail to provide any feedback mechanism for recognizing the escalation of network traffic, other than the eventual overflow of buffers. As a result, existing designs often contribute to significant yet avoidable losses in network capabilities under high network traffic conditions.

### BRIEF SUMMARY OF THE INVENTION

The present invention relates to a method for managing packets in a network comprising the steps of receiving a packet, assigning the packet to a selected one of a plurality of classes, checking a counter associated with the selected class, advancing the counter toward the target value and forwarding the packet if the counter is not equal to a target value, dropping the packet if the counter is equal to the target value, and from time to time, resetting the counter to a reset value not equal to the target value to allow more packets from the selected class to be forwarded.

In one embodiment, the counter is scheduled to be repeatedly reset according to a period, which may be implemented by use of a timer. The period can be changed to effectuate a different rate of packet forwarding for the selected class. The reset value can also be changed to effectuate a different rate of packet forwarding for the selected class. Further, the target value can also be changed to effectuate a different rate of packet forwarding for the selected class. In one embodiment, a different rate of packet forwarding for the selected class is effectuated in response to at least one measure of processor load. A different rate of packet forwarding for the selected class may also be effectuated in response to at least one measure of storage load. Further, a different rate of packet forwarding for the selected class may be effectuated in response to at least one measure of packet congestion. The counter may be reset as a task having a lower priority than at least another task. Also, the lower priority task may be scheduled according to a period.

According to one embodiment, the receiving, assigning, checking, forwarding, and dropping steps are performed by a first process, and the resetting step is performed by a second process. The first process may be associated with a data plane, and the second process may be associated with a control plane.

### BRIEF DESCRIPTION OF THE DRAWINGS

FIG. 1 depicts an illustrative network environment in which the present invention may be utilized.

FIG. 2 is a simplified block diagram of network device demonstrating one embodiment of the present invention.

FIGS. 3A-C illustrate an example of how packets of a particular class are forwarded and dropped in accordance with one embodiment of the invention.

FIGS. 4A-C illustrate processing of three different classes of packets in accordance with one embodiment of the invention.

FIG. 5 is a flow chart outlining various steps for processing packets in accordance with one embodiment of the present invention.

### DETAILED DESCRIPTION OF THE INVENTION

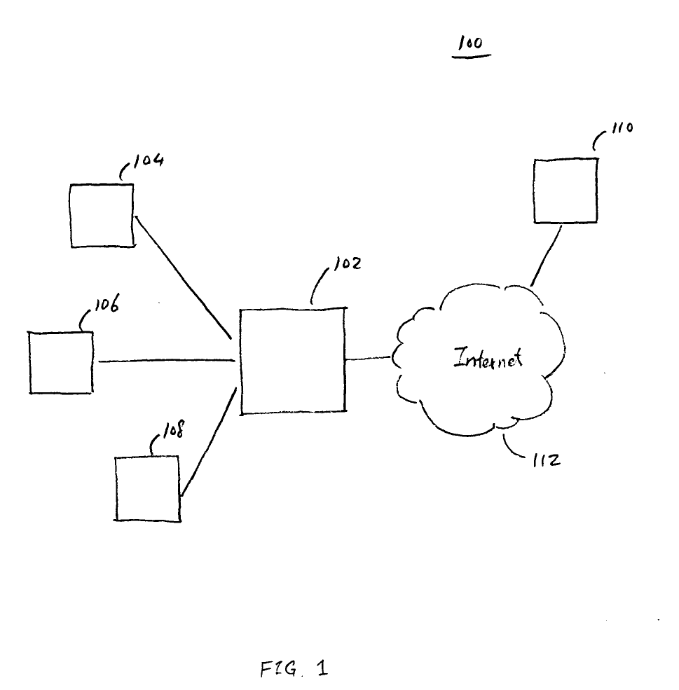

FIG. 1 depicts an illustrative network environment 100 in which the present invention may be utilized. As shown, network environment 100 includes a network device 102 that is coupled to a number of other network devices 104, 106, and 108. Network device 102 is coupled to another network device 110 through the Internet 112. These network devices may represent different types of network equipment, including repeaters, hubs, bridges, switches, routers, gateways, specialized networking devices, and the like. This particular arrangement of these network devices is only one illustration. Other arrangements may be used in accordance with the present invention. For example, network device 102 is shown to be located at the “edge” of the Internet 112. In other arrangements, network device 102 may be located within the Internet 112. Also, various topologies such as rings, stars, buses, and others may be used in accordance with the present invention. Further, while simple lines are used to demonstrate coupling between devices in FIG. 1, such coupling may involve intermediate equipment not shown in the figure.

In accordance with one embodiment of the invention, network device 102 receives packets of information from network devices 104, 106, 108, and 110. Network device 102 may also transmit packets to network devices 104, 106, 108, and 110. Here, the term “packet” refers generally to a portion of digital information. While it is not necessary, a packet may include a header and a payload, which can contain another packet. Thus, a packet may comprise data arranged in a nested fashion. The packets may represent various types of data associated with different protocols, at different levels communication, and possibly for different networking systems. The packets may also refer to data packets or control packets. For example, the packets may represent Point-to-Point Protocol (PPP) configuration request packets, PPP echo request packets, PPP echo reply packets, Point-to-Point Protocol over Ethernet (PPPoE) discovery packets, broadcast Internet Protocol (IP) packets, route protocol packets, just to name a few. According to the present embodiment, network device 102 efficiently manages undesirably high levels of network traffic by discarding at least a portion of the received packets in a systematic and efficient manner.

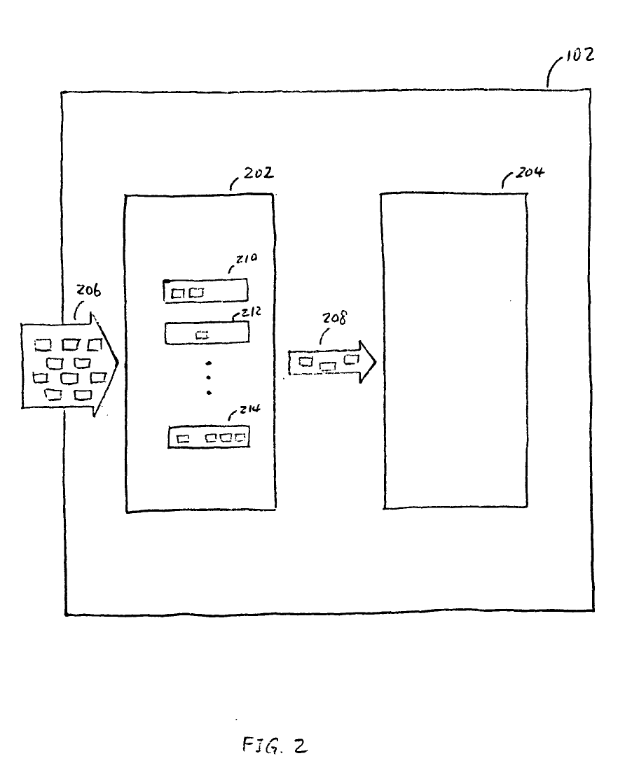

FIG. 2 is a simplified block diagram of network device 102 demonstrating one embodiment of the present invention. As shown, network device 102 includes a data plane 202 and a control plane 204. Data plane 202 may operate at a relatively higher speed than control plane 204. Data plane 202 and control plane 204 may each include a combination of hardware and software, such as different processors, application-specific integrated circuits (ASICs), programmable devices, logic circuits, and various type of software code. While they are shown in FIG. 2 to be contained within network device 102, data plane 202 and control plane 204 may be implemented as equipment distributed to multiple locations.

As shown in FIG. 2, the network device 102 receives a large number of control packets 206. The data plane 202 processes the control packets 206. At least a portion 208 of the control packets 206 are forwarded to the control plane 204. The class-based process described below limits the number of packets forwarded from the data plane 202 to the control plane 204. More specifically, while some packets are forwarded, other are dropped. Dropped packets are either discarded permanently or processed in some alternative fashion, such as being stored for later processing or studied statistically. In the present embodiment, it is desirable to limit the number of packets forwarded to control plane 204 because processing of packets at control plane 204 may require significant resources. By limiting the number of packets forwarded to control plane 204, system inefficiencies or failures caused by overloading of resources associated with control plane 204 may thus be averted. However, the present invention is applicable to other situations where high levels of network traffic need to be controlled and is not restricted to the specific application of limiting of packets forwarded to a control plane. Also, the present invention is generally applicable to management of packets and is not restricted to particular types of packets, such as data packets or control packets.

Referring back to FIG. 2, in order to determine which packets are to be forwarded and which packets are to be dropped, and when to do so, data plane 202 assigns each of the packets to one of N classes, such as classes 210, 212, and 214. In one implementation, N=8, so there are 8 distinct classes. Other values for N are possible and are within the scope of the present embodiment of the invention. Each class is associated with a counter (not shown) that keeps track of how many packets from the class has been forwarded since the last reset of the counter. For a given class, once a certain number of packets from the class have been forwarded, additional packets from that class are dropped, until the counter for the class is reset. The counter can be reset according to a schedule specific to the class, for example once per second, to allow more packets from the class to be forwarded. Such periodic resets can be accomplished by use of a timer (not shown) associated with the class. Alternatively, the counter can be reset by some other method. According to the present invention, counters and timers may be implemented in hardware, software, a combination of hardware and software, or by some other means.

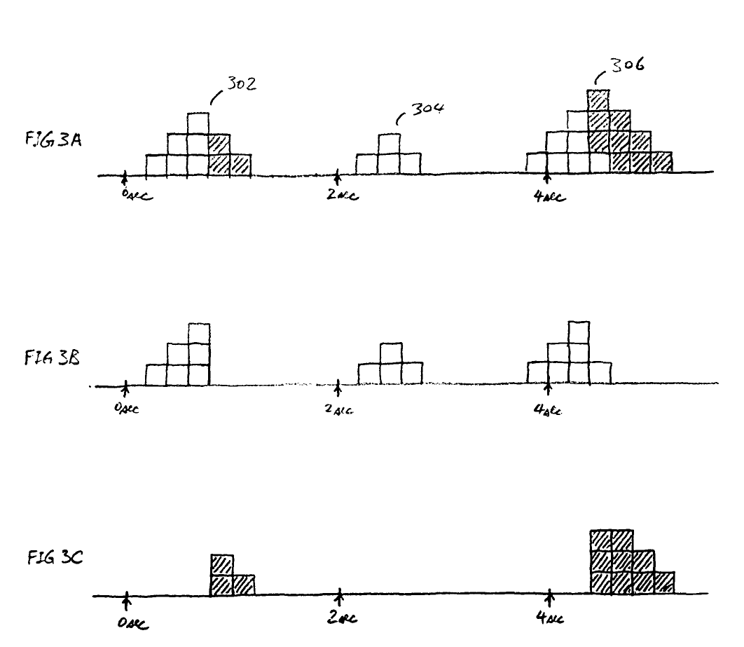

FIGS. 3A-C illustrate an example of how packets of a particular class are forwarded and dropped in accordance with one embodiment of the invention. Here, a counter associated with this particular class ensures that a maximum number of 6 packets from the class are allowed to be forwarded, until the counter is reset. A timer associated with the class is used to reset the counter once every 2 seconds. FIG. 3A shows some of the packets of this particular class, before they are forwarded or dropped. As shown, the packets make up three distinct groups 302, 304, and 306. The first group 302 contains a total of 9 packets and is processed after a reset of the counter at time=0 sec. Thus, the first 6 packets (unshaded) from group 302 can be forwarded. The remaining 3 packets (shaded) from group 302 are to be dropped. In fact, until the next reset of the counter, any additional packets of this class would also be dropped. The next reset of the counter occurs at time=2 sec. Group 304 contains a total of 4 packets and is processed after the reset of the counter at time=2 sec. Thus, all 4 packets (unshaded) from group 304 can be forwarded. The next reset of the counter occurs at time=4 sec. Group 305 contains a total of 16 packets and is processed, for the most part, after the reset of the counter at time=4 sec. However, the first packet of group 306 is actually processed prior to the reset of the counter at time=4 sec. Because only 4 packets have been counted since the previous reset of the counter at time=2 sec., there is room for 2 more packets to be forwarded, and thus the first packet (unshaded) of group 306 can be forwarded. At time=4 seconds, the counter is reset for 6 more packets to be forwarded. Thus, 6 packets (unshaded) of the remaining 15 packets from group 306 can be forwarded. The other 9 packets (shaded) of the remaining 15 packets from group 306 would be dropped. FIG. 3B more clearly shows which packets from FIG. 3A are to be forwarded, and FIG. 3C more clearly shows which packets from FIG. 3A are to be dropped. The number of packets and specific counter and timer values demonstrated in FIGS. 3A-C are chosen to provide a simple illustration. Different numbers and values are within the scope of the present invention.

According to one embodiment, a count-down counter can be employed. For example, the count-down timer for a particular class may be initially set to a value of 6. Before forwarding each packet from this class, the current value of the count-down counter is checked. If the current value of the count-down counter is non-zero, the count-down timer is decremented by 1 and the packet in question is forwarded. If the current value of the count-down counter is zero, the packet in question is dropped. Thus, once the count-down timer reaches zero, additional packets from this class would be dropped until the count-down timer is reset to 6 or some other non-zero value. Alternatively, a count-up counter, or some other type of counting mechanism, may be used.

For each class of packets, the rate by which packets are forwarded may thus be adjusted by either changing the reset value of the count-down counter (or the target value of a count-up counter), or changing the frequency by which counters are reset, or both. For example, resetting a count-down counter to a high value allows more packets to be forwarded before the count-down counter decrements to zero. Resetting a count-down counter more frequently allows the counter to restart at a non-zero value more often, and thus allowing more packets to be forwarded over a given period of time. In this manner, the rate by which packets are forwarded can be systematically controlled, on a class-by-class basis.

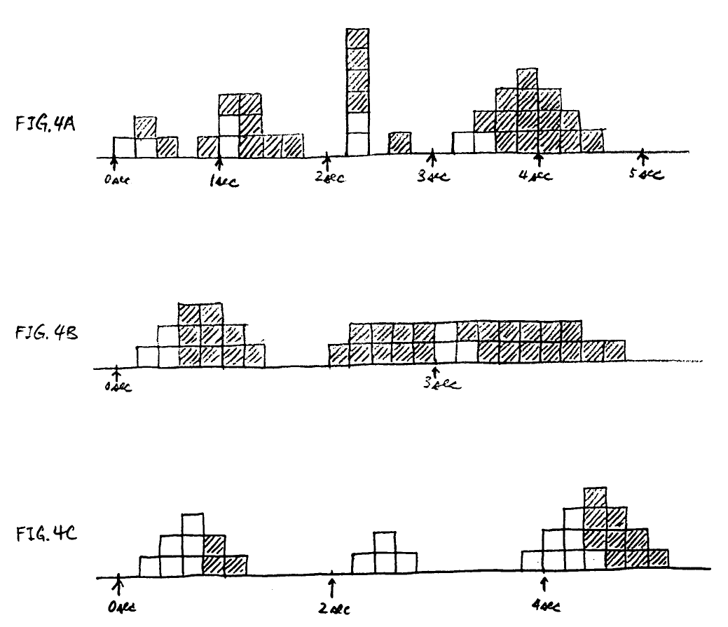

FIGS. 4A-C illustrate processing of three different classes of packets in accordance with one embodiment of the invention. Each class is associated with a counter that keeps track of how many packets from the class are forwarded, as well as a timer that resets the counter periodically. The table below summarizes, for each class, the maximum number of packets allowed to be forwarded until the next reset of the counter, as well as the period by which the counter is reset using the timer.

| Maximum # of Packets | Counter Reset Every |
|---|---|
| 2 | 1 sec. |
| 3 | 3 sec. |
| 6 | 2 sec. |

As shown in FIGS. 4A-C, the packets that are allowed to be forwarded are marked as unshaded, and the packets to be dropped are marked as shaded. The number of packets and specific counter and timer values demonstrated in FIGS. 4A-C are chosen to provide a simple illustration. Different numbers and values are within the scope of the present invention.

According to one embodiment of the invention, feedback information can be used to throttle the rate by which packets are forwarded. Such use of feedback can also be implemented on a class-by-class basis. For example, for a given class, the maximum number of packets allowed to be forwarded until the next reset of the counter, as well as the period by which the counter is reset using the timer, or both, can be dynamically modified in response to certain conditions, such as indications of excessive processor load, storage load, and/or some other measure. Thus, the rate by which packets of a particular class are forwarded can be decreased, for instance, if build-up of packets for that class, build-up of packets generally, or some other condition, is detected. This allows the system to adjust to changing conditions to maximize the efficient use of packet processing resources.

According to another embodiment of invention, the task of resetting the counter associated with a given class can be performed by a device, such as a processor, as a lower priority task. The task may still be scheduled to occur on a periodic basis. For example, the counter reset may be carried out by a processor as an interrupt-driven event that corresponds to a lower priority interrupt occurring once per second. However, if the processor is busy performing higher priority tasks when a particular counter reset is scheduled to occur, the counter reset may not be performed right away. Because the counter is not reset, packets of the corresponding class will continue to be dropped once the maximum number of packet allowed to be forwarded (until the next reset of the counter) is reached. These packets are dropped until the processor is less busy and able to perform the lower priority task of resetting the counter, effectively slowing rate by which packets are forwarded. This results in an additional approach by which the rate of packet forwarding can be dynamically controlled in response to indications of load on the system. In the present example, the combination of the maximum number of packet allowed to be forwarded until the next counter reset and the period of the counter reset (for example, maximum count of 6 packets and a counter reset period of 2 seconds) may establish a ceiling for the rate of packet forwarding for a particular class. That is, packets will not be forwarded faster than 6 packets every 2 seconds. However, the rate may not necessarily stay at 6 packets every 2 seconds—it may slow down in response to the processor becoming busy.

According to at least one embodiment of the invention, one or more classes of packets can be dynamically added or deleted during operation of the system. This provides additional flexibility in the management of packets. As new packet classes are needed, they can be quickly added without re-compiling software code. Also, as certain packet classes become less useful, they can be quickly deleted in a similar manner.

Further, the data plane 202 and the control plane 204 can both contribute to control of packet forwarding. In one embodiment, data plane 202 may be responsible for assigning each packet to the appropriate class, checking the counter associated with the class to see if the more packets from the class can be forwarded, forwarding the packet to data plane 204 and increments/decrements the counter when appropriate, and discarding the packet when appropriate. Data plane 204 may perform these tasks at relatively higher speeds, for a large number of packets. Control plane 204, on the other hand, may simply be responsible for resetting the counter for each class. By setting the reset/target value of the counter, control plane 204 can control the maximum number of packet allowed to be forwarded until the next reset of the counter is reached. Control plane 204 can also control how often the counter for each class is reset. In this manner, control plane 204 can adjust the rate by which packets of the class are forwarded to control plane 204 on a class-by-class basis. Control plane 204 may perform these tasks at relatively lower speeds. Such division of tasks between data plane 202 and control plane 204 may be implemented according to one embodiment of the invention.

Referring back to FIG. 2, data plane 202 and control plane 204 may both access common components, such as storage. For example, while packets are shown in FIG. 2 to be passed into data plane 202, and out of data plane 202 and toward control plane 204, packets may actually be stored in memory components not necessarily located inside data plane 202. Packets may be stored in memory components accessible to both data plane 202 and control plane 204. Such memory components may be located outside of both data plane 202 and control plane 204. Assignment of different packets to different classes need not take place within data plane 202. Also, forwarding of packets from data plane 202 to control plane 204 does necessarily require the physical transfer of packets, but may involve manipulation of pointers, addresses, and the like, associated with different memory locations.

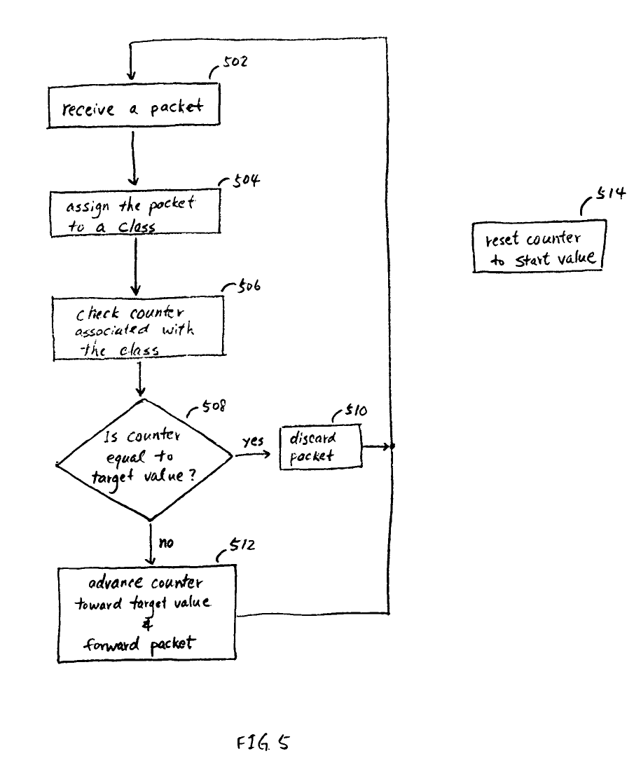

FIG. 5 is a flow chart outlining various steps for processing packets in accordance with one embodiment of the present invention. In this embodiment, data plane 202 is responsible for steps 502-512, while control plane 204 is responsible step 514. At step 512, a packet is received. At step 504, the packet is assigned to a class. The class may be one of a plurality of classes. At step 506, a counter associated with the class is checked. At step 508, if the counter is equal to a target value, the process proceeds to step 510, where the packet is discarded. At step 508, if the counter is not equal to the target value, the process proceeds to step 512, where the counter is advanced toward the target value and the packet is forwarded. After step 510 or step 512, the process next proceeds back to step 502. At step 514, which can be a separate or related process as steps 502-512, the counter is reset.

1. A method for managing packets in a network comprising:
receiving a packet;
assigning the packet to a selected one of a plurality of classes;
checking a counter associated with the selected class;
advancing the counter toward a target value and forwarding the packet if the counter is not equal to the target value;
dropping the packet if the counter is equal to the target value; and
from time to time, resetting the counter to a reset value not equal to the target value to allow more packets from the selected class to be forwarded.

2. The method of claim 1 wherein the counter is scheduled to be repeatedly reset according to a period.

3. The method of claim 2 wherein the period is implemented by use of a timer.

4. The method of claim 2 wherein the period can be changed to effectuate a different rate of packet forwarding for the selected class.

5. The method of claim 1 wherein the reset value can be changed to effectuate a different rate of packet forwarding for the selected class.

6. The method of claim 1 wherein the target value can be changed to effectuate a different rate of packet forwarding for the selected class.

7. The method of claim 1 wherein the reset value is a non-zero integer and the target value is zero.

8. The method of claim 1 wherein the reset value is zero and the target value is a non-zero integer.

9. The method of claim 1 wherein a different rate of packet forwarding for the selected class is effectuated in response to at least one measure of processor load.

10. The method of claim 1 wherein a different rate of packet forwarding for the selected class is effectuated in response to at least one measure of storage load.

11. The method of claim 1 wherein a different rate of packet forwarding for the selected class is effectuated in response to at least one measure of packet congestion.

12. The method of claim 1 wherein said step of resetting the counter is performed as a task having a lower priority than at least another task.

13. The method of claim 12 wherein the lower priority task is scheduled according to a period.

14. The method of claim 1 wherein said steps for receiving, assigning, checking, forwarding, and dropping are performed by a first process, and said step for resetting is performed by a second process.

15. The method of claim 14 wherein the first process is carried out by a first processor, and the second process is carried out by a second processor.

16. The method of claim 14 wherein the first process is associated with a faster processing speed than the second process.

17. The method of claim 14 wherein the first process is associated with a data plane, and the second process is associated with a control plane.

18. The method of claim 1 wherein a new class for assignment of packets can be dynamically added to the plurality of classes during operation.

19. An apparatus for managing packets in a network comprising:
a data plane operable to
receive a packet,
assign the packet to a selected one of a plurality of classes,
check a counter associated with the selected class,
advance the counter toward a target value and forwarding the packet if the counter is not equal to the target value, and
drop the packet if the counter is equal to the target value; and
a control plane coupled to the data plane, the control plane operable to reset the counter, from time to time, to a reset value not equal to the target value to allow more packets from the selected class to be forwarded.

20. The apparatus of claim 19 wherein the counter is scheduled to be repeatedly reset according to a period.

21. The apparatus of claim 20 wherein the period is implemented by use of a timer.

22. The apparatus of claim 20 wherein the period can be changed to effectuate a different rate of packet forwarding for the selected class.

23. The apparatus of claim 19 wherein the reset value can be changed to effectuate a different rate of packet forwarding for the selected class.

24. The apparatus of claim 19 wherein the target value can be changed to effectuate a different rate of packet forwarding for the selected class.

25. The apparatus of claim 19 wherein the reset value is a non-zero integer and the target value is zero.

26. The apparatus of claim 19 wherein the reset value is zero and the target value is a non-zero integer.

27. The apparatus of claim 19 wherein a different rate of packet forwarding for the selected class is effectuated in response to at least one measure of processor load.

28. The apparatus of claim 19 wherein a different rate of packet forwarding for the selected class is effectuated in response to at least one measure of storage load.

29. The apparatus of claim 19 wherein a different rate of packet forwarding for the selected class is effectuated in response to at least one measure of packet congestion.

30. The apparatus of claim 19 wherein the counter is reset by a task having a lower priority than at least another task.

31. The apparatus of claim 30 wherein the lower priority task is scheduled according to a period.

32. The apparatus of claim 19 wherein the data plane comprises at least a first processor, and the control plane comprises at least a second processor.

33. The apparatus of claim 32 wherein the first processor is associated with a faster processing speed than the second processor.

34. The apparatus of claim 19 wherein a new class for assignment of packets can be dynamically added to the plurality of classes during operation.

35. A system for managing packets in a network comprising:
means for receiving a packet;
means for assigning the packet to a selected one of a plurality of classes;
means for checking a counter associated with the selected class;
means for advancing the counter toward a target value and forwarding the packet if the counter is not equal to the target value;
means for dropping the packet if the counter is equal to the target value; and
means for resetting the counter, from time to time, to a reset value not equal to the target value to allow more packets from the selected class to be forwarded.

36. A method for managing packets in a network comprising:
receiving a packet;
assigning the packet to a selected one of a plurality of classes, the selected class being associated with a maximum limit on number of packets from the selected class to be forwarded during an interval of interest;
forwarding the received packet if number of packets from the selected class forwarded during the interval of interest has not reached the maximum limit; and
dropping the received packet if number of packets from the selected class forwarded during the interval of interest has reached the maximum limit.

37. The method of claim 1 wherein duration of the interval of interest can be changed to effectuate a different rate of packet forwarding for the selected class.

38. The method of claim 1 wherein the maximum limit can be changed to effectuate a different rate of packet forwarding for the selected class.

39. An apparatus for managing packets in a network comprising:
an architecture having a data plane operable to receive a packet,
assign the packet to a selected one of a plurality of classes, the selected class being associated with a maximum limit on number of packets from the selected class to be forwarded during an interval of interest,
forward the received packet if number of packets from the selected class forwarded during the interval of interest has not reached the maximum limit, and
drop the received packet if number of packets from the selected class forwarded during the interval of interest has reached the maximum limit.

40. A system for managing packets in a network comprising:
means for receiving a packet;
means for assigning the packet to a selected one of a plurality of classes, the selected class being associated with a maximum limit on number of packets from the selected class to be forwarded during an interval of interest;
means for forwarding the received packet if number of packets from the selected class forwarded during the interval of interest has not reached the maximum limit; and
means for dropping the received packet if number of packets from the selected class forwarded during the interval of interest has reached the maximum limit.
